(19) United States
(12) Patent Application Publication
(10) Pub. No.: US 2011/0273909 A1
(43) Pub. Date: Nov. 10, 2011

(54) FULL-BRIDGE PHASE-SHIFT CONVERTER WITH AUXILIARY ZERO-VOLTAGE-SWITCHING CIRCUIT

(75) Inventor: Cheung-Tak SIT Christopher, Taipei Hsien (TW)

(73) Assignee: Chicony Power Technology Co., Ltd.

(21) Appl. No.: 12/773,107

(22) Filed: May 4, 2010

(51) Int. Cl. H02M 3/335

(52) U.S. Cl. 363/17

(57) ABSTRACT

A full-bridge phase-shift converter with an auxiliary zero-voltage-switching circuit includes a full-bridge switching circuit, an isolated transformer, an auxiliary zero-voltage-switching (ZVS) circuit, a full-wave rectifying circuit, and a low-pass filtering circuit. The full-bridge phase-shift converter is used to send energy which is supplied from a DC input voltage to a load. Therefore, an auxiliary inductor of the auxiliary ZVS circuit is provided to reinforce sufficient inductive energy on a leading-edge leg, thus achieving normally zero-voltage-switching operations of the full-bridge phase-shift converter.

### BACKGROUND OF THE INVENTION

1. Field of the Invention

The present invention relates to a full-bridge phase-shift converter, and more particularly to a full-bridge phase-shift converter with an auxiliary zero-voltage-switching circuit.

2. Description of Prior Art

With the development of power semiconductor technology, many electronic produces are now light, thin, short, and small, and this trend will continue. The traditional linear power supply has cumbersome isolated transformers and heat sinks therein, thus the linear power supply has already been eliminated gradually due to low efficiency. Instead of the linear power supply, the switching power supply is used for high-frequency operations. The switching power supply has a lot of advantages, including smaller volume, lighter weight, and higher efficiency.

In general, the switching power supply adopts a traditional hard switching technology. When the operation frequency increases, therefore, the switching losses of turning on and turning off the power switching elements will increase with frequency. However, this will result in large heat losses to reduce efficiency and lifetime of the switching power supply. In addition, the heat dissipating apparatus is needed to install, while volume and costs increase. More particularly, non-ideal effect of switching the power switching elements causes problems of higher voltage and current stress as well as electromagnetic interference.

In order to overcome the above-mentioned problems, a soft switching technology is applied to various power electronic products. The soft switching technology can be broadly classified into two types: (1) zero voltage switching (ZVS), and (2) zero current switching (ZCS). The ZVS is achieved to reduce the voltage across the power switching element to zero before turning on the power switching element, whereas the ZCS is achieved to reduce the current through the power switching element to zero before turning on the power switching element. The soft switching technology—ZVS or ZCS, is achieved by producing a zero power of multiplying the voltage across the power switching element and the current through thereof. Accordingly, this will reduce switching losses, increase efficiency, and reduce noises of the power switching elements. However, the ZCS is achieved to cause switching losses due to electric charges stored in the power switching elements. Hence, the ZVS is preferred for high-frequency operations.

Generally speaking, full-bridge phase-shift converters are commonly used in medium- and high-power DC-to-DC conversion circuits. Reference is made to FIG. 1 which is a circuit diagram of a prior art full-bridge phase-shift zero-voltage-switching (ZVS) converter. The full-bridge phase-shift ZVS converter mainly includes a full-bridge switching circuit 10A, an isolated transformer 20A, a full-wave rectifying circuit 30A, and a low-pass filtering circuit 40A.

The full-bridge switching circuit 10A is electrically connected to a DC input voltage Vga. The isolated transformer 20A has a primary-side winding (not labeled) and a secondary-side winding (not labeled). The primary-side winding (including a primary-side leakage inductance Lea) of the isolated transformer 20A is electrically connected to the full-wave rectifying circuit 30A. The low-pass filtering circuit 40A is electrically connected to the full-wave rectifying circuit 30A. Hence, the full-bridge phase-shift ZVS converter transmits energy provided from the DC input voltage Vga to a connected load RLa.

The full-wave rectifying circuit 30A has a first rectifying diode SR1a and a second rectifying diode SR2a. The full-wave rectifying circuit 30A is electrically connected to the secondary-side winding of the isolated transformer 20A to rectify the output voltage of the secondary-side winding of the isolated transformer 20A. The low-pass filtering circuit 40A is composed of an output filtering inductor Loa and an output filtering capacitor Coa. The low-pass filtering circuit 40A is electrically connected to the full-wave rectifying circuit 30A to filter out high-frequency harmonic components of the rectified output voltage of the full-wave rectifying circuit 30A, thus providing an output voltage (not labeled) with a required voltage level to the load RLa.

The full-bridge switching circuit 10A has four power switching elements, namely, a first power switching element Q1a, a second power switching element Q2a, a third power switching element Q3a, and a fourth power switching element Q4a. More particularly, each of the four power switching elements Q1a-Q4a has an anti-parallel diode, also called body diode (not labeled), and a parasitic capacitance (not labeled). Because the first power switching element Q1a and the second power switching element Q2a are turned on at the rising-edge-triggered effective PWM signal, the first power switching element Q1a and the second power switching element Q2a form a leading-edge leg (not labeled). On the other hand, because the third power switching element Q3a and the fourth power switching element Q4a are turned on at the falling-edge-triggered effective PWM signal, the third power switching element Q3a and the fourth power switching element Q4a from a lagging-edge leg (not labeled).

For the lagging-edge leg, the energy used to achieve ZVS is basically the reflected load current. This is available since the inductor current has not flywheel state through the full-wave rectifying circuit 30A until the primary-side current Ipr reaches zero. Hence, the inductive energy associated for the lagging-edge leg can be described as follows:

Elag=0.5×Lm×Im²+0.5×n²×Loa×(ILoap/n)²+0.5×Lea×(Im+ILoap/n)² (equation 1)

wherein, Elag is the inductive energy produced by the lagging-edge leg; Im is the magnetizing current of the primary-side winding of the isolated transformer 20A; ILoap is the maximum current through the output filtering inductor Loa; the symbol n is the turn ratio between the primary-side winding and the secondary-side winding of the isolated transformer 20A.

Since the energy in the output filter inductor Loa of the low-pass filtering circuit 40A is large compared to that required to charge or discharge the capacitance in the primary side, ZVS is achieved easily for the third power switching element Q3a and the fourth power switching element Q4a of the lagging-edge leg over the entire load range.

Unlike the lagging-edge leg, however, ZVS in the leading-edge leg is provided by the resonance between the primary-side leakage inductance Lea and the parasitic capacitances of the first power switching element Q1a and the second power switching element Q2a. Hence, the inductive energy associated for the leading-edge leg can be expressed as follows:

Elead=0.5×Lea×(Ipr+Im)² (equation 2)

wherein, Elead is the inductive energy produced by the leading-edge leg.

At light load, the inductive energy may not be sufficient and thus ZVS of the first power switching element Q1a and the second power switching element Q2a is lost. Accordingly, the full-bridge phase-shift ZVS converter is not suitable for large varying load conditions.

Accordingly, it is desirable to provide a full-bridge phase-shift converter with an auxiliary zero-voltage-switching circuit to reinforce sufficient inductive energy on the leading-edge leg.

### SUMMARY OF THE INVENTION

In order to achieve the above-mentioned objects, a full-bridge phase-shift converter with an auxiliary zero-voltage-switching circuit is disclosed. The full-bridge phase-shift converter is electrically connected to a DC input voltage to transmit energy provided from the DC input voltage to a connected load. The full-bridge phase-shift converter includes a full-bridge switching circuit, an isolated transformer, an auxiliary zero-voltage-switching circuit, a full-wave rectifying circuit, and a low-pass filtering circuit.

The full-bridge switching circuit has four power switching elements, namely, a first power switching element, a second power switching element, a third power switching element, and a fourth power switching element, to switch the DC input voltage into a rectangular voltage. More particularly, each of the power switching elements has an anti-parallel diode and a parasitic capacitance. The first power switching element and the second power switching element form a leading-edge leg, and the third power switching element and the fourth power switching element from a lagging-edge leg.

The isolated transformer has a primary-side winding and a secondary-side winding, and the primary-side winding is electrically connected to the full-bridge switching circuit to receive the rectangular voltage and vary the magnitude of the rectangular voltage according to the turn ratio between the primary-side winding and the secondary-side winding.

The auxiliary zero-voltage-switching circuit has a first auxiliary capacitor, a second auxiliary capacitor, and an auxiliary inductor. The first auxiliary capacitor has a first terminal and a second terminal. The first terminal is electrically connected to the first power switching element and the third power switching element of the full-bridge switching circuit. The second auxiliary capacitor has a first terminal and a second terminal. The first terminal is electrically connected to the second terminal of the first auxiliary capacitor, and the second terminal is electrically connected to the second power switching element and the fourth power switching element of the full-bridge switching circuit. The auxiliary inductor has a first terminal and a second terminal. The first terminal is electrically connected to the second terminal of the first auxiliary capacitor, and the second terminal is electrically connected to the primary-side winding of the isolated transformer.

The full-wave rectifying circuit is electrically connected to the secondary-side winding of the isolated transformer to rectify an output voltage from the secondary-side winding.

The low-pass filtering circuit is electrically connected to the full-wave rectifying circuit to filter out high-frequency harmonic components of the rectified output voltage of the full-wave rectifying circuit.

Therefore, the auxiliary inductor of the auxiliary zero-voltage-switching circuit is used to reinforce sufficient inductive energy on the leading-edge leg, thus achieving normally zero-voltage-switching operations of the full-bridge phase-shift converter.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a prior art full-bridge phase-shift zero-voltage-switching (ZVS) converter;

FIG. 2 is a full-bridge phase-shift converter with an auxiliary ZVS circuit according to the present invention;

FIG. 3 is a timing and voltage/current waveform diagram of the full-bridge phase-shift converter;

FIG. 4A is an equivalent circuit diagram of the full-bridge phase-shift operated under an energy transfer state; and

FIG. 4B is an equivalent circuit diagram of the full-bridge phase-shift operated under a flywheel state.

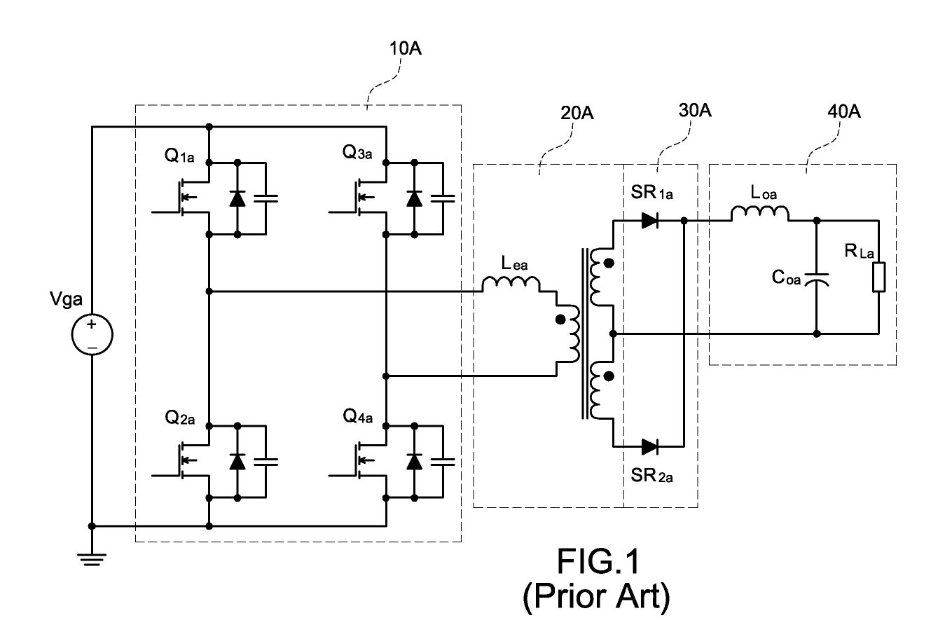

### DETAILED DESCRIPTION OF THE INVENTION

Reference will now be made to the drawing figures to describe the present invention in detail.

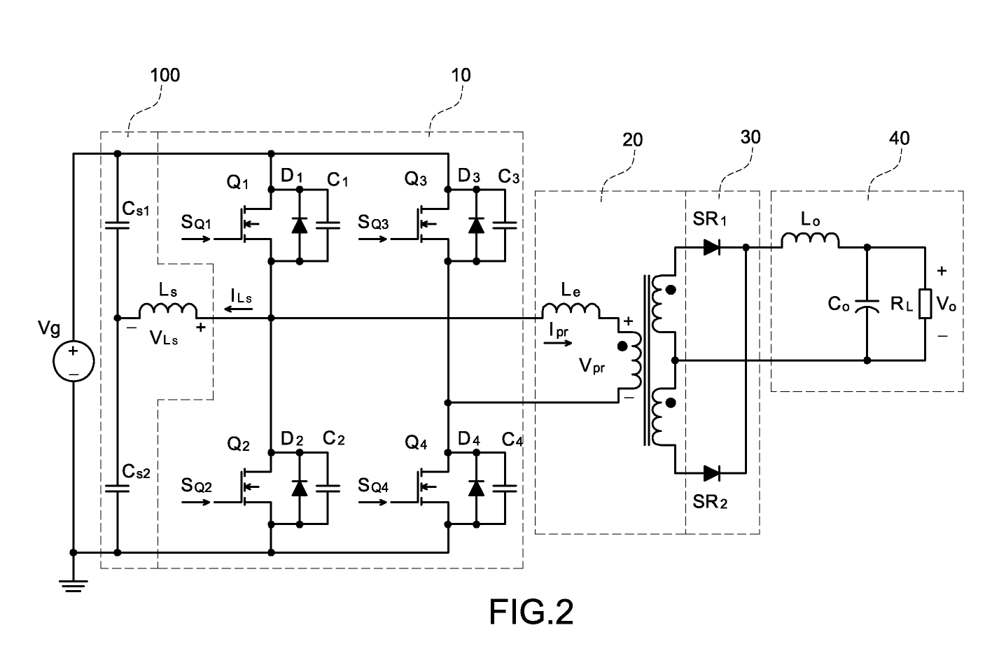

Reference is made to FIG. 2 which is a full-bridge phase-shift converter with an auxiliary ZVS circuit according to the present invention. The full-bridge phase-shift converter is electrically connected to a DC input voltage Vg to transmit energy provided from the DC input voltage Vg to a connected load RL. The full-bridge phase-shift converter mainly includes a full-bridge switching circuit 10, an isolated transformer 20, a full-wave rectifying circuit 30, and a low-pass filtering circuit 40. The significant difference between the prior art full-bridge phase-shift ZVS converter and the present invention is that the latter further includes an auxiliary zero-voltage-switching circuit 100.

The full-bridge switching circuit 10 has four power switching elements, namely, a first power switching element Q1, a second power switching element Q2, a third power switching element Q3, and a fourth power switching element Q4. The full-bridge switching circuit 10 is used to switch the DC input voltage Vg into a rectangular voltage. More particularly, each of the power switching elements Q1-Q4 has an anti-parallel diode D1-D4 (also called body diode) and a parasitic capacitance C1-C4. Namely, the first power switching element Q1 is electrically connected in parallel to the first diode D1 and the first parasitic capacitance C1; the second power switching element Q2 is electrically connected in parallel to the second diode D2 and the second parasitic capacitance C2; the third power switching element Q3 is electrically connected in parallel to the third diode D3 and the third parasitic capacitance C3; and the fourth power switching element Q4 is electrically connected in parallel to the fourth diode D4 and the fourth parasitic capacitance C4. In addition, the first power switching element Q1 and the second power switching element Q2 form a leading-edge leg (not labeled), and the third power switching element Q3 and the fourth power switching element Q4 form a lagging-edge leg (not labeled).

The isolated transformer 20 has a primary-side wining (not labeled) and a secondary-side winding (not labeled). In addition, the isolated transformer 20 has a primary-side leakage inductance Le which is electrically connected in series to the primary-side winding. More particularly, the secondary-side winding is a center-tapped winding. The isolated transformer 20 is electrically connected to the full-bridge switching circuit 10 to receive the rectangular voltage and vary the magnitude of the rectangular voltage according to the turn ratio between the primary-side winding and the secondary-side winding. In addition, the isolated transformer 20 also provides an isolation function between the primary-side circuit and the secondary-side circuit.

The auxiliary zero-voltage-switching circuit 100 includes a first auxiliary capacitor Cs1, a second auxiliary capacitor Cs2, and an auxiliary inductor Ls. The first auxiliary capacitor Cs1 has a first terminal (not labeled) and a second terminal (not labeled). The first terminal is electrically connected to the first power switching element Q1 and the third power switching element Q3 of the full-bridge switching circuit 10, namely, the upper-arm power switching elements of the full-bridge switching circuit 10. The second auxiliary capacitor Cs2 has a first terminal (not labeled) and a second terminal (not labeled). The first terminal is electrically connected to the second terminal of the first auxiliary capacitor Cs1, and the second terminal is electrically connected to the second power switching element Q2 and the fourth power switching element Q4 of the full-bridge switching circuit 10, namely, the lower-arm power switching elements of the full-bridge switching circuit 10. The auxiliary inductor Ls has a first terminal (not labeled) and a second terminal (not labeled). The first terminal is electrically connected to the second terminal of the first auxiliary capacitor Cs1, and the second terminal is electrically connected to the primary-side winding of the isolated transformer 20.

The full-wave rectifying circuit 30 has a first rectifying diode SR1 and second rectifying diode SR2. Also, the full-wave rectifying circuit 30 is electrically connected to the secondary-side winding of the isolated transformer 20 to rectify an output voltage from the secondary-side winding of the isolated transformer 20. The low-pass filtering circuit 40 has an output filtering inductor Lo and an output filtering capacitor Co. Also, the low-pass filtering circuit 40 is electrically connected to the full-wave rectifying circuit 30 to filter out high-frequency harmonic components of the rectified output voltage of the full-wave rectifying circuit 30, thus providing an output voltage Vo with a required voltage level to the load RL.

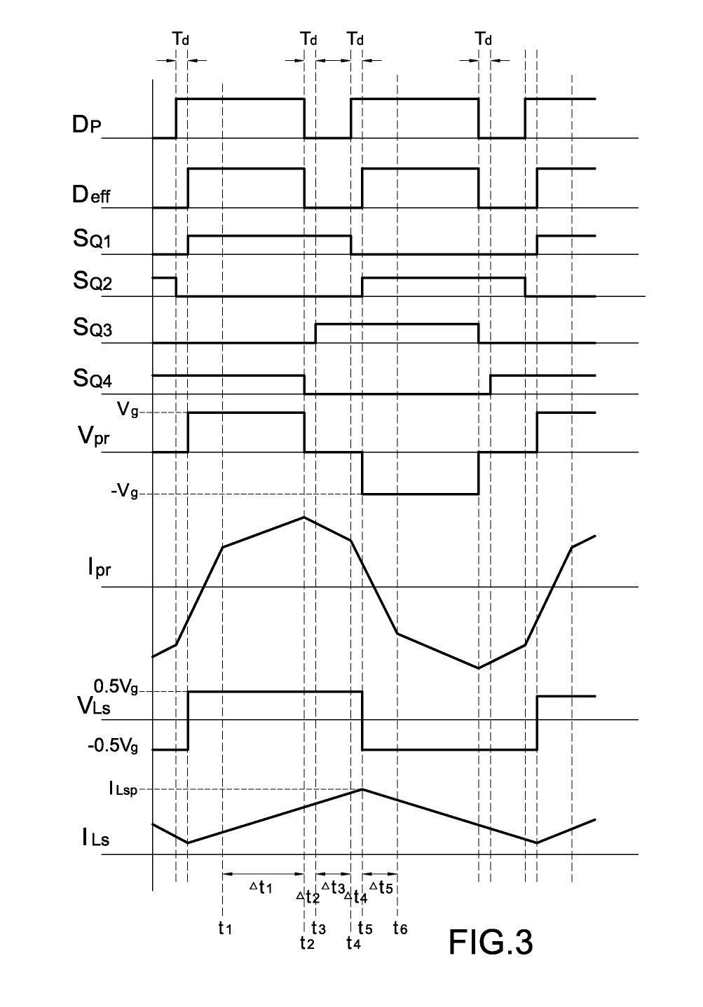

In addition, the full-bridge phase-shift converter with an auxiliary ZVS circuit is associated with a feedback control circuit (not shown). By controlling different phase shift between these power switching elements Q1˜Q4, thus the output voltage Vo is regulated. That is to say, the feedback control circuit is provided to minimize voltage variation of the output voltage V0 influenced by the DC input voltage Vg or the connected load RL. The feedback control circuit mainly includes a voltage compensation circuit (not shown) and a phase-shift PWM controller (not shown). The voltage compensation circuit is electrically connected to the low-pass filtering circuit 40 to receive the output voltage V0 from the full-bridge phase-shift converter and produce an output compensation voltage. The phase-shift PWM controller is electrically connected to the voltage compensation circuit to receive the output compensation voltage and produce four switch driving signals. More particularly, the output compensation voltage is provided to control a duty cycle Dp (as shown in FIG. 3) of the phase-shift PWM controller. The four switch driving signals, namely, a first switch driving signal SQ1, a second switch driving signal SQ2, a third switch driving signal SQ3, and a fourth switch driving signal SQ4 are provided to control the first power switching element Q1, the second power switching element Q2, the third power switching element Q3, and the fourth power switching element Q4, respectively. That is, the first switch driving signal SQ1 is provided to turn on or turn off the first power switching element Q1, the second switch driving signal SQ2 is provided to turn on or turn off the second power switching element Q2, the third switch driving signal SQ3 is provided to turn on or turn off the third power switching element Q3, and the fourth switch driving signal SQ4 is provided to turn on or turn off the fourth power switching element Q4.

The first switch driving signal SQ1 and the second switch driving signal SQ2 are complementary-level voltage signals, and the third switch driving signal SQ3 and the fourth switch driving signal SQ4 (as shown in FIG. 3). In addition, due to non-linearity in a solid-state switching element, such as turn-on delay and turn-off delay, the power switching elements Q1˜Q4 do not immediately turn-on or turn-off when being driven by an input trigger command. In order to avoid the first switch driving signal SQ1 and the second switch driving signal SQ2 (namely, the leading-edge leg) or the third switch driving signal SQ3 and the fourth switch driving signal SQ4 (namely, the lagging-edge leg) turning on or turning off simultaneously, a delay time Td has to be added. More particularly, the delay time Td plays an important role in achieving ZVS of these power switching elements Q1˜Q4. After the delay time Td was taken into account, an effective duty cycle Deff is the actual duty cycle of the phase-shift PWM controller.

Reference is made to FIG. 3 which is a timing and voltage/current waveform diagram of the full-bridge phase-shift converter. The detailed description of the operation sequences of the full-bridge phase-shift converter during different time intervals will be made hereinafter with reference to FIG. 3.

1. First Time Interval Δt1 (from First Time t1 to Second Time t2)

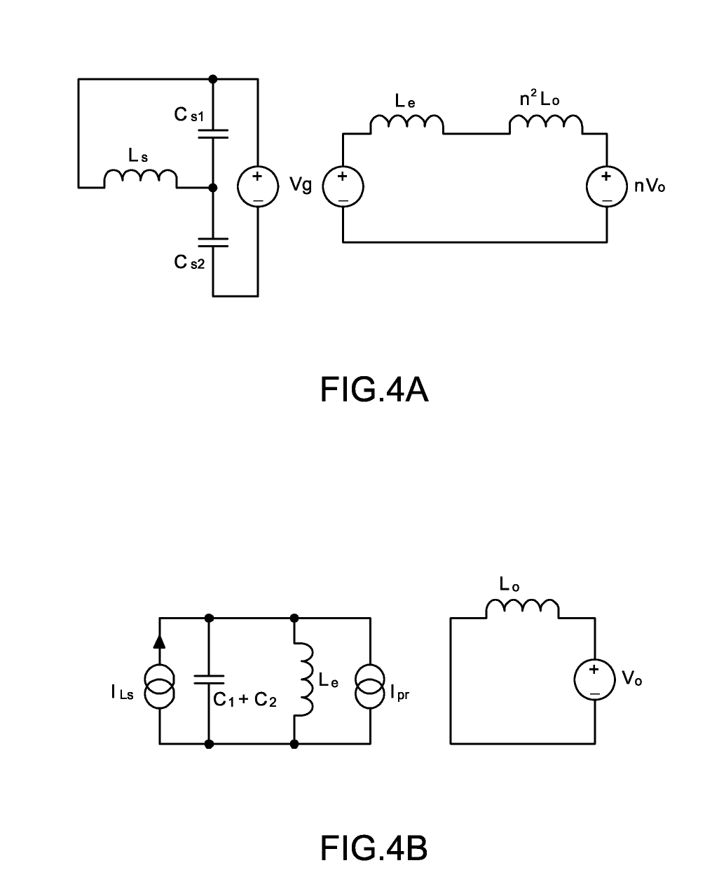

The first time interval Δt1 is also called an energy transfer interval. Initially, the first power switching element Q1 and the fourth power switching element Q4 are turned on, and the second power switching element Q2 and the third power switching element Q3 are turned off. The DC input voltage Vg is provided through the first power switching element Q1 and the second power switching element Q2, thus the voltage across the auxiliary inductor Ls of the auxiliary zero-voltage-switching circuit 100 (namely, the auxiliary inductor voltage VLs) is equal to one half of the DC input voltage Vg. Also, the voltage across the primary-side winding of the isolated transformer 20 is equal to the DC input voltage Vg. The primary-side leakage inductance Le is charged to store magnetic energy, thus the primary-side current Ipr of the isolated transformer 20 increases gradually. More particularly, the primary-side voltage Vpr is induced to the secondary side of the isolated transformer 20. At this time, the first rectifying diode SR1 of the full-wave rectifying circuit 30 is forward biased to be turned on, and the second rectifying diode SR2 is reverse biased to be turned off. The energy is transferred from the source terminal to the load terminal through the isolated transformer 20. An equivalent circuit diagram of the full-bride phase-shift operated under the energy transfer state (during the first time interval Δt1) is shown in FIG. 4A.

2. Second Time Interval Δt2 (from Second Time t2 to Third Time t3)

When t=t2, the fourth power switching element Q4 is turned off and the primary-side current Ipr of the isolated transformer 20 increases to the maximum value. The fourth parasitic capacitance C4 of the fourth power switching element Q4 is charged by the DC input voltage Vg, and the third parasitic capacitance C3 of the third power switching element Q3 is discharged. Accordingly, the drain-source voltage of the fourth power switching element Q4 is equal to the DC input voltage Vg. When t=t3, the third diode D3 of the third power switching element Q3 provides a voltage-clamping function, thus the drain-source voltage of the third power switching element Q3 is near zero to achieve ZVS.

3. Third Time Interval Δt3 (from Third Time t3 to Fourth Time t4)

When t=t3, the third diode D3 is turned on to flow a large portion of current to the third diode D3, thus to achieve ZVS of the third power switching element Q3.

4. Fourth Time Interval Δt4 (from Fourth Time t4 to Fifth Time t5)

When t=t4, the first power switching element Q1 is turned off The primary-side leakage inductance Le of the isolated transformer 20 and the first parasitic capacitance C1 of the first power switching element Q1 are charged, and the second parasitic capacitance C2 of the second power switching element Q2 is discharged. When t=t5, an auxiliary inductor current ILs through the auxiliary inductor Ls increases to the maximum value, namely, a maximum auxiliary inductor current ILsp. At this time, the first rectifying diode SR1 and the second rectifying diode SR2 of the full-wave rectifying circuit 30 are turned on simultaneously. Hence, the secondary-side circuit of the isolated transformer 20 is to a flywheel state so that the primary side is in a short-circuit state. Accordingly, the output filtering inductor Lo does not be reflected to the primary side of the isolated transformer 20 because the voltage of the primary-side winding and that of the secondary-side winding are both zero. Because the primary-side of the isolated transformer 20 can not provide sufficient energy, the voltage of the secondary side of the isolated transformer 20 is near zero. During the short-circuit interval, FIG. 4B shows an equivalent circuit diagram of the full-bridge phase-shift operated under the flywheel state. Accordingly, the auxiliary inductor Ls is considered as a current source. In addition, the resonance of the first power switching element Q1 and the second power switching element Q2 is achieved through the primary-side leakage inductance Le of the isolated transformer 20 (namely, the equivalent resonance inductance) and the first parasitic capacitance C1 and the second parasitic capacitance C2 (namely, the equivalent resonance capacitance). Accordingly, the auxiliary inductor Ls of the auxiliary zero-voltage-switching circuit 100 is added to increase the primary-side current Ipr, thus reinforcing sufficient energy of charging and discharging the first parasitic capacitance C1 and the second parasitic capacitance C2.

5. Fifth Time Interval Δt5 (from Fifth Time t5 to Sixth Time t6)

When t=t5, the second diode D2 and the second power switching element Q2 are turned on, thus the drain-source voltage of the second power switching element Q2 is near zero to achieve ZVS. At this time, because the primary-side current Ipr of the isolated transformer 20 ramps down linearly to zero, the second diode D2 and the third diode D3 are turned off and the primary-side current Ipr continues to go negative. When t=t6, the primary-side current Ipr decreases to the minimum value.

The above-mentioned description is that the full-bridge phase-shift converter with an auxiliary ZVS circuit is operated in a positive half-cycle. In addition, because the operation in a positive half-cycle is symmetrical to that in a negative half-cycle, the detail description of the operation in the negative half-cycle is omitted here for conciseness.

The auxiliary zero-voltage-switching circuit 100 is provided to increase the current through the leading-edge leg, namely, the first power switching element Q1 and the second power switching element Q2 without interfere operation of a power stage. Under the normal operation of the full-bridge phase-shift converter and large varying load conditions, hence, the auxiliary inductor Ls is designed to provide sufficient inductive energy on the leading-edge leg for charging and discharging the first parasitic capacitance C1 and the second parasitic capacitance C2. Hence, the inductive energy associated for the leading-edge leg can be described as follows:

Elead=0.5×Le×(Ipr+Im)²+0.5×Ls×ILsp² (equation 3)

wherein, the Elead is the inductive energy produced by the leading-edge leg; the Im is the magnetizing current of the primary-side winding of the isolated transformer 20; the ILsp is the maximum value of the current through the auxiliary inductor current ILs.

Comparing the equation 3 and the equation 2, the reinforced energy provided by the auxiliary inductor Ls of the auxiliary zero-voltage-switching circuit 100 is equal to 0.5×Ls×ILsp².

Therefore, the auxiliary inductor Ls is provided to reinforce sufficient inductive energy on the leading-edge leg, thus achieving normally zero-voltage-switching operations of the full-bridge phase-shift converter. Furthermore, the full-bridge phase-shift converter can be operated over the entire load range under the maximum effective duty cycle provided.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A full-bridge phase-shift converter with an auxiliary zero-voltage-switching circuit electrically connected to a DC input voltage to transmit energy provided from the DC input voltage to a connected load; the full-bridge phase-shift converter comprising:
a full-bridge switching circuit having four power switching elements to switch the DC input voltage into a rectangular voltage;
wherein the four power switching elements are a first power switching element, a second power switching element, a third power switching element, and a fourth power switching element, respectively; the first power switching element and the second power switching element forming a leading-edge leg, and the third power switching element and the fourth power switching element forming a lagging-edge leg; each of the four power switching elements has an anti-parallel diode and a parasitic capacitance;
an isolated transformer having a primary-side winding and a secondary-side winding, and the primary-side winding electrically connected to the full-bridge switching circuit to receive the rectangular voltage and vary the magnitude of the rectangular voltage according to the turn ratio between the primary-side winding and the secondary-side winding;
an auxiliary zero-voltage-switching circuit comprising:
a first auxiliary capacitor having a first terminal and a second terminal; wherein the first terminal is electrically connected to the first power switching element and the third power switching element of the full-bridge switching circuit;
a second auxiliary capacitor having a first terminal and a second terminal; wherein the first terminal is electrically connected to the second terminal of the first auxiliary capacitor, and the second terminal is electrically connected to the second power switching element and the fourth power switching element of the full-bridge switching circuit; and
an auxiliary inductor having a first terminal and a second terminal; wherein the first terminal is electrically connected to the second terminal of the first auxiliary capacitor, and the second terminal is electrically connected to the primary-side winding of the isolated transformer;
a full-wave rectifying circuit electrically connected to the secondary-side winding of the isolated transformer to rectify an output voltage from the secondary-side winding; and
a low-pass filtering circuit electrically connected to the full-wave rectifying circuit to filter out high-frequency harmonic components of the rectified output voltage of the full-wave rectifying circuit;
whereby the auxiliary inductor of the auxiliary zero-voltage-switching circuit is used to reinforce sufficient inductive energy on the leading-edge leg, thus achieving normally zero-voltage-switching operations of the full-bridge phase-shift converter.

2. The full-bridge phase-shift converter in claim 1, further comprising:
a voltage compensation circuit electrically connected to the low-pass filtering circuit to receive an output voltage from the full-bridge phase-shift converter and produce an output compensation voltage; and
a phase-shift PWM controller electrically connected to the voltage compensation circuit to receive the output compensation voltage and produce four switch driving signals;
wherein the four switch driving signals are a first switch driving signal, a second switch driving signal, a third switch driving signal, and a fourth switch driving signal, and the four switch driving signals are provided to turn on and turn off the first power switching element, the second power switching element, the third power switching element, and the fourth power switching element, respectively.

3. The full-bridge phase-shift converter in claim 2, wherein the first switch driving signal and the second switch driving signal are complementary-level voltage signals.

4. The full-bridge phase-shift converter in claim 2, wherein the third switch driving signal and the fourth switch driving signal are complementary-level voltage signals.

5. The full-bridge phase-shift converter in claim 1, wherein the resonance of the first power switching element and the second power switching element is achieved through the primary-side leakage inductance of the isolated transformer and the first parasitic capacitance and the second parasitic capacitance.

6. The full-bridge phase-shift converter in claim 1, wherein the resonance of the third power switching element and the fourth power switching element is achieved through the primary-side leakage inductance of the isolated transformer and the third parasitic capacitance and the fourth parasitic capacitance.

7. The full-bridge phase-shift converter in claim 1, wherein the secondary-side winding of the isolated transformer is a center-tapped winding.

8. The full-bridge phase-shift converter in claim 1, wherein the low-pass filtering circuit is composed of an inductor and a capacitor.
